(19) United States
(12) Patent Application Publication
(10) Pub. No.: US 2021/0390949 A1
(43) Pub. Date: Dec. 16, 2021

(54) SYSTEMS AND METHODS FOR PHONEME AND VISEME RECOGNITION

(71) Applicant: Netflix, Inc., Los Gatos, CA (US)

(72) Inventors: Yadong Wang, Campbell, CA (US); Shilpa Jois Rao, Cupertino, CA (US); Murthy Parthasarathi, Fremont, CA (US)

(21) Appl. No.: 16/903,373

(22) Filed: Jun. 16, 2020

(51) Int. Cl. G10L 15/08; G10L 15/04; G10L 15/02; G10L 21/0232; G06N 20/00

(52) U.S. Cl. CPC G10L 15/08; G10L 15/04; G10L 2015/025; G10L 21/0232; G06N 20/00; G10L 15/02

(57) ABSTRACT

The disclosed computer-implemented method may include training a machine-learning algorithm to use look-ahead to improve effectiveness of identifying visemes corresponding to audio signals by, for one or more audio segments in a set of training audio signals, evaluating an audio segment, where the audio segment includes at least a portion of a phoneme, and a subsequent segment that includes contextual audio that comes after the audio segment and potentially contains context about a viseme that maps to the phoneme. The method may also include using the trained machine-learning algorithm to identify one or more probable visemes corresponding to speech in a target audio signal. Additionally, the method may include recording, as metadata of the target audio signal, where a probable viseme occurs within the target audio signal. Various other methods, systems, and computer-readable media are also disclosed.

### BACKGROUND

Languages include distinct sounds known as phonemes, and even very different languages include some of the same phonemes. While phonemes represent different sounds in human speech, visemes represent different visual cues that indicate speech. For example, a viseme may be distinguished by the shape of a person's mouth, the space between the person's lips, the position of the person's tongue, the position of the person's jaw, and so forth. However, due to limitations in distinctive visual cues, and allowing for personal differences, a viseme may represent multiple phonemes. For example, the shape of a person's mouth often looks very similar when pronouncing an “f” sound compared to a “v” sound, though they may audibly sound like distinct phonemes.

In industries like voice dubbing and translation services, the ability of a viseme to represent multiple phonemes is advantageous for a variety of reasons. Translated words that match similar visemes are easier to find than words that match the exact phonemes of original speech, and accurately matching phonemes to visemes in a video reduces dissonance for consumers watching the video. In other words, matching words to visemes rather than the original phonemes is easier when each viseme is matched to multiple other phonemes. However, in order to determine the potential visemes or phonemes in a video or audio file, traditional methods typically involve manual identification of phonemes and when they occur. For example, a translator may listen to an audio file and indicate the timestamps of each word or phoneme, which may be a time-consuming process. In addition, when a speaker is off-screen in a video, there may be no reliable data to determine the correct visemes representing the speech. Thus, improved methods of accurately identifying phonemes or visemes from audio data are needed to improve this process.

### SUMMARY

As will be described in greater detail below, the present disclosure describes systems and methods for automatically identifying phonemes and visemes. In one example, a computer-implemented method for automatically identifying phonemes and visemes includes training a machine-learning algorithm to use look-ahead to improve the effectiveness of identifying visemes corresponding to audio signals by, for one or more audio segments in a set of training audio signals, evaluating an audio segment, where the audio segment includes at least a portion of a phoneme, and evaluating a subsequent segment that includes contextual audio that comes after the audio segment and potentially contains context about a viseme that maps to the phoneme. The method also includes using the trained machine-learning algorithm to identify one or more probable visemes corresponding to speech in a target audio signal. Additionally, the method includes recording, as metadata of the target audio signal, where a probable viseme occurs within the target audio signal.

In some embodiments, training the machine-learning algorithm includes identifying a start time and an end time for each phoneme in the set of training audio signals by detecting prelabeled phonemes. Additionally or alternatively, training the machine-learning algorithm includes aligning estimated phonemes to a script of each training audio signal in the set of training audio signals.

In one example, training the machine-learning algorithm includes extracting a set of features from the set of training audio signals, where each feature in the set of features includes a spectrogram indicating energy levels of a training audio signal, and training the machine-learning algorithm on the set of training audio signals is performed using the extracted set of features. In this example, extracting the set of features includes, for each training audio signal, 1) dividing the training audio signal into overlapping windows of time, 2) performing a transformation on each windowed audio signal to convert a frequency spectrum for the window of time to a power spectrum indicating a spectral density of the windowed audio signal, 3) computing filter banks for the training audio signal by applying filters that at least partially reflect a scale of human hearing to each power spectrum, and 4) calculating the spectrogram of the training audio signal by combining coefficients of the filter banks. Additionally, in this example, extracting the set of features further includes first applying a pre-emphasis filter to the set of training audio signals to balance frequencies and reduce noise in the set of training audio signals. In the above example, dividing the training audio signal includes applying a window function to taper the windowed audio signal within each overlapping window of time of the training audio signal. Furthermore, in the above example, calculating the spectrogram includes performing a logarithmic function to convert the frequency spectrum to a mel scale, extracting frequency bands by applying the filter banks to each power spectrum, performing an additional transformation to the filter banks to decorrelate the coefficients of the filter banks, and/or computing a new set of coefficients from the transformed filter banks. In some examples, extracting the set of features includes standardizing the set of features for the set of training audio signals to scale the set of features.

In one embodiment, training the machine-learning algorithm includes, for each audio segment in the set of training audio signals, calculating, for one or more visemes, the probability of the viseme mapping to the phoneme of the audio segment. Additionally, training the machine-learning algorithm includes selecting the viseme with a high probability of mapping to the phoneme based on the context from the subsequent segment and modifying the machine-learning algorithm based on a comparison of the selected viseme to a known mapping of visemes to phonemes. In this embodiment, calculating the probability of mapping one or more visemes to the phoneme includes weighting visually distinctive visemes more heavily than other visemes. Additionally, in this embodiment, selecting the viseme with the high probability of mapping to the phoneme further includes adjusting the selection based on additional context from a prior segment that includes additional contextual audio that comes before the audio segment.

In some examples, training the machine-learning algorithm further includes validating the machine-learning algorithm using a set of validation audio signals and testing the machine-learning algorithm using a set of test audio signals. In these examples, validating the machine-learning algorithm includes standardizing the set of validation audio signals, applying the machine-learning algorithm to the standardized set of validation audio signals, and evaluating an accuracy of mapping visemes to phonemes of the set of validation audio signals by the machine-learning algorithm. Additionally, in these examples, testing the machine-learning algorithm includes standardizing the set of test audio signals, applying the machine-learning algorithm to the standardized set of test audio signals, comparing an accuracy of mapping visemes to phonemes of the set of test audio signals by the machine-learning algorithm with an accuracy of one or more alternate machine-learning algorithms, and selecting an accurate machine-learning algorithm based on the comparison.

In some embodiments, recording where the probable viseme occurs within the target audio signal includes identifying and recording a probable start time and a probable end time for each identified probable viseme in the target audio signal.

In one example, the above method further includes identifying a set of phonemes that map to each identified probable viseme in the target audio signal. In this example, the above method also includes recording, as metadata of the target audio signal, where the set of phonemes occur within the target audio signal.

In addition, a corresponding system for automatically identifying phonemes and visemes includes several modules stored in memory, including a training module that trains a machine-learning algorithm to use look-ahead to improve the effectiveness of identifying visemes corresponding to audio signals by, for one or more audio segments in a set of training audio signals, evaluating an audio segment, where the audio segment includes at least a portion of a phoneme, and evaluating a subsequent segment that includes contextual audio that comes after the audio segment and potentially contains context about a viseme that maps to the phoneme. Additionally, in some embodiments, the system includes an identification module that uses the trained machine-learning algorithm to identify one or more probable visemes corresponding to speech in a target audio signal. Furthermore, the system includes a recording module that records, as metadata of the target audio signal, where the probable viseme occurs within the target audio signal. Finally, the system includes one or more processors that execute the training module, the identification module, and the recording module.

In some embodiments, the identification module uses the trained machine-learning algorithm to identify a probable phoneme corresponding to the speech in the target audio signal and/or a set of alternate phonemes that map to the probable viseme corresponding to the probable phoneme in the target audio signal. In these embodiments, the recording module provides, to a user, the metadata indicating where the probable viseme occurs within the target audio signal and the set of alternate phonemes that map to the probable viseme to improve selection of translations for the speech in the target audio signal.

In some examples, the above-described method is encoded as computer-readable instructions on a computer-readable medium. For example, a computer-readable medium may include one or more computer-executable instructions that, when executed by at least one processor of a computing device, cause the computing device to train a machine-learning algorithm to use look-ahead to improve the effectiveness of identifying visemes corresponding to audio signals by, for at least one audio segment in a set of training audio signals, evaluating the audio segment, where the audio segment includes at least a portion of a phoneme, and evaluating a subsequent segment that includes contextual audio that comes after the audio segment and potentially contains context about a viseme that maps to the phoneme. The instructions may also cause the computing device to use the trained machine-learning algorithm to identify one or more probable visemes corresponding to speech in a target audio signal. Additionally, the instructions may cause the computing device to record, as metadata of the target audio signal, where the probable viseme occurs within the target audio signal.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for automatically identifying phonemes and visemes.

FIG. 2 is a block diagram of an exemplary computing device for automatically identifying phonemes and visemes.

FIG. 3 illustrates an exemplary mapping of visemes and phonemes.

FIG. 4 illustrates an exemplary audio signal with exemplary labels for phonemes corresponding to an exemplary script.

FIG. 5 is a block diagram of an exemplary feature extraction for an exemplary set of features.

FIG. 6 illustrates the extraction of an exemplary spectrogram as a feature.

FIG. 7 is a block diagram of exemplary training of an exemplary machine-learning algorithm.

FIG. 8 is a block diagram of exemplary validation and testing of an exemplary machine-learning algorithm.

FIGS. 9A and 9B illustrate two exemplary machine-learning algorithms for identifying phonemes and visemes.

FIG. 10 illustrates a simplified mapping of a detected viseme in an exemplary audio signal.

FIG. 11 illustrates an exemplary detection of phonemes and visemes in an exemplary target audio signal.

FIG. 12 is a block diagram of an exemplary set of alternate phonemes that map to an exemplary phoneme or viseme.

FIG. 13 is an example of an interface for presenting viseme recognition results.

FIG. 14 is a block diagram of an exemplary content distribution ecosystem.

FIG. 15 is a block diagram of an exemplary distribution infrastructure within the content distribution ecosystem shown in FIG. 14.

FIG. 16 is a block diagram of an exemplary content player within the content distribution ecosystem shown in FIG. 14.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to automatically identifying phonemes and visemes corresponding to audio data. As will be explained in greater detail below, embodiments of the present disclosure improve the identification of phonemes and visemes correlated to an audio signal at a specific point in time by training a machine-learning algorithm to use audio data before and after the point in time to provide context for the audio signal. In some examples, a detection system first extracts features from training audio files by calculating a spectrogram for each audio file. The detection system then trains a machine-learning algorithm using the features to detect phonemes and correlated visemes in the training audio files. For example, the detection system may train a neural network to detect phonemes based on audio signals and compare the results against manually labeled phonemes to improve the accuracy of detection. By subsequently applying the trained machine-learning algorithm to a target audio signal, the detection system identifies phonemes or visemes that are the most probable correlations for the audio signal at each point in time. Additionally, the detection system records the probable phonemes or visemes in the metadata for the audio signal file to provide start and end time labels to a user.

Traditional methods for detecting phonemes and visemes sometimes utilize manual labor or may only be able to learn from past data. For example, some traditional systems predict phonemes for a frame of an audio file by looking back at previous phonemes prior to the frame. However, manual labeling of phonemes and visemes is often time consuming and involves extensive knowledge of languages. In addition, using past data to predict future phonemes and visemes for an audio file limits the ability to detect changes and new phonemes or visemes, thereby limiting the accuracy of such methods. By also incorporating a look-ahead method to review context from audio occurring later, the disclosed systems and methods better determine the relevant phonemes and visemes for a given point in time. Furthermore, by mapping visemes to sets of phonemes, the disclosed systems and methods identify potential alternate phonemes that correspond to a detected viseme and that can be used to create alternate audio for translation dubbing.

One or more of the systems and methods described herein improve the functioning of a computing device by improving the efficiency and accuracy of processing audio files and labeling phonemes and visemes through a look-ahead approach. In addition, these systems and methods may also improve the fields of language translation and audio dubbing by determining potential phonemes, and therefore potential translated words, that map to detected visemes. Finally, by mapping visemes to correlated phonemes, these systems and methods may also improve the fields of animation or reanimation to determine the visemes required to visually match spoken language or audio dubbing. The disclosed systems and methods may also provide a variety of other features and advantages in identifying phonemes and visemes.

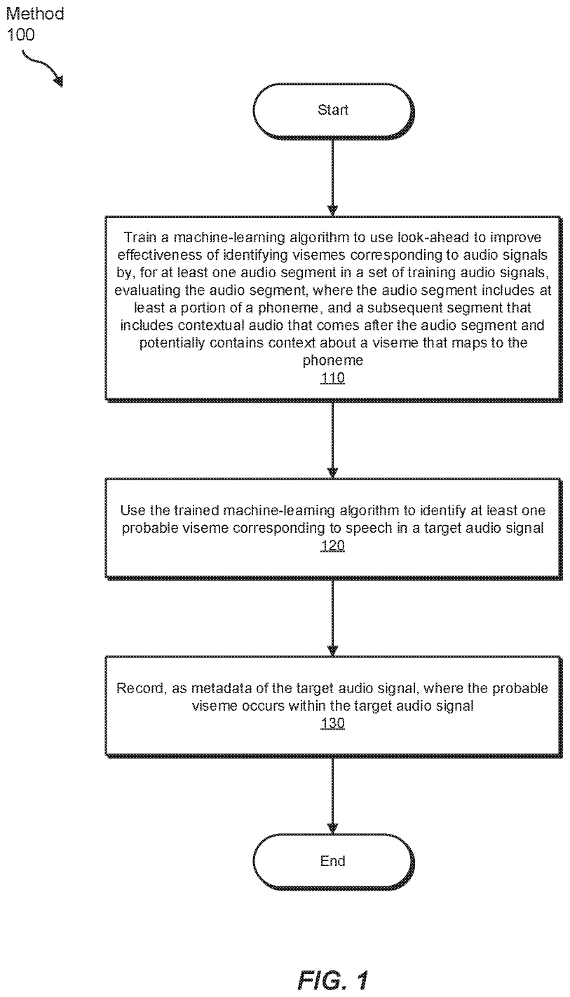

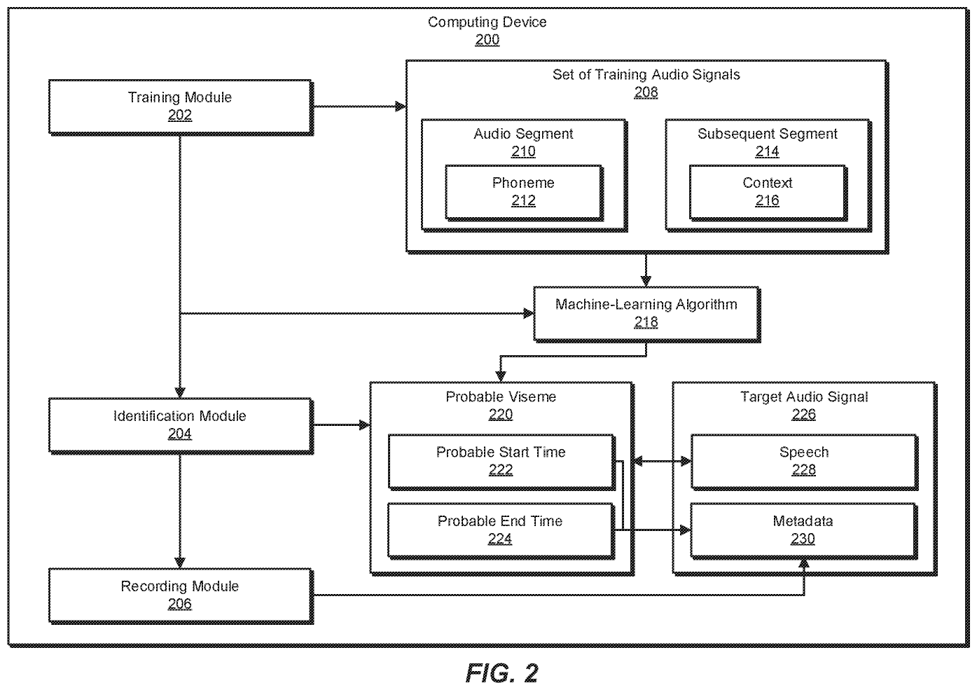

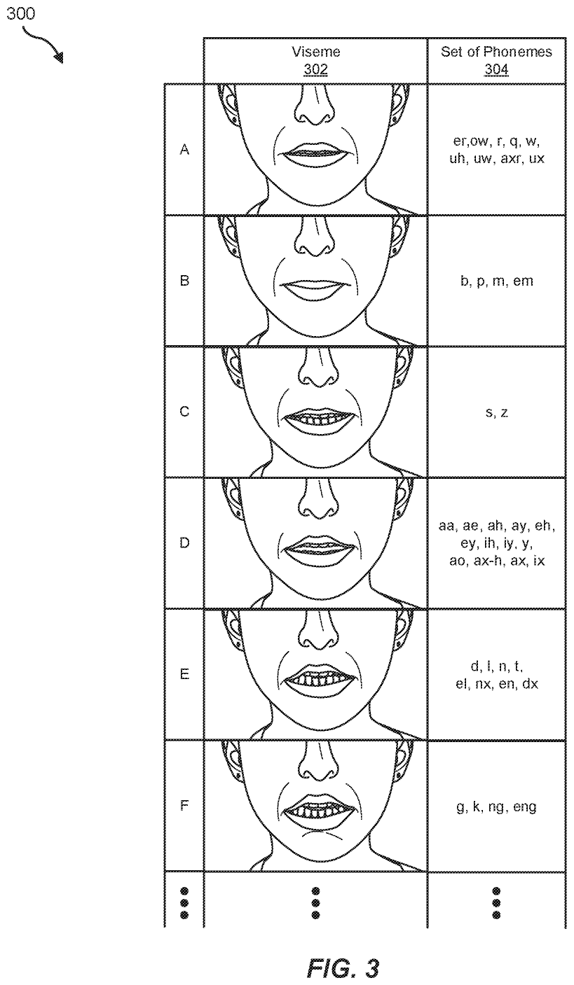

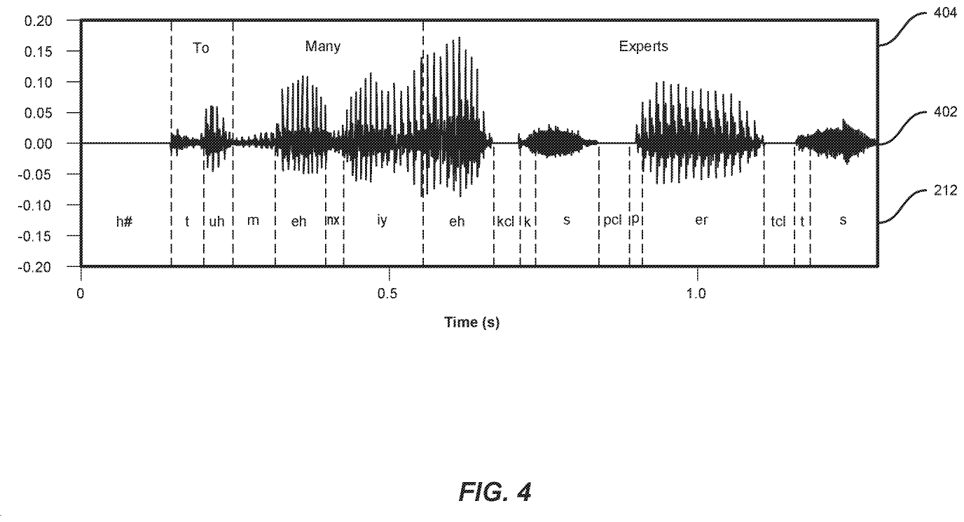

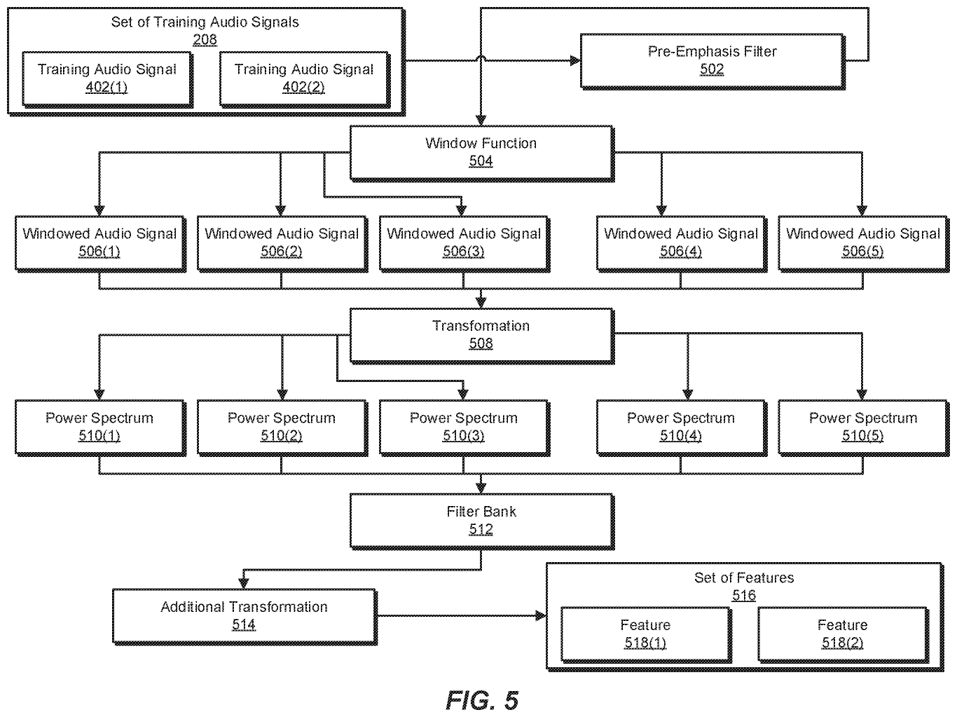

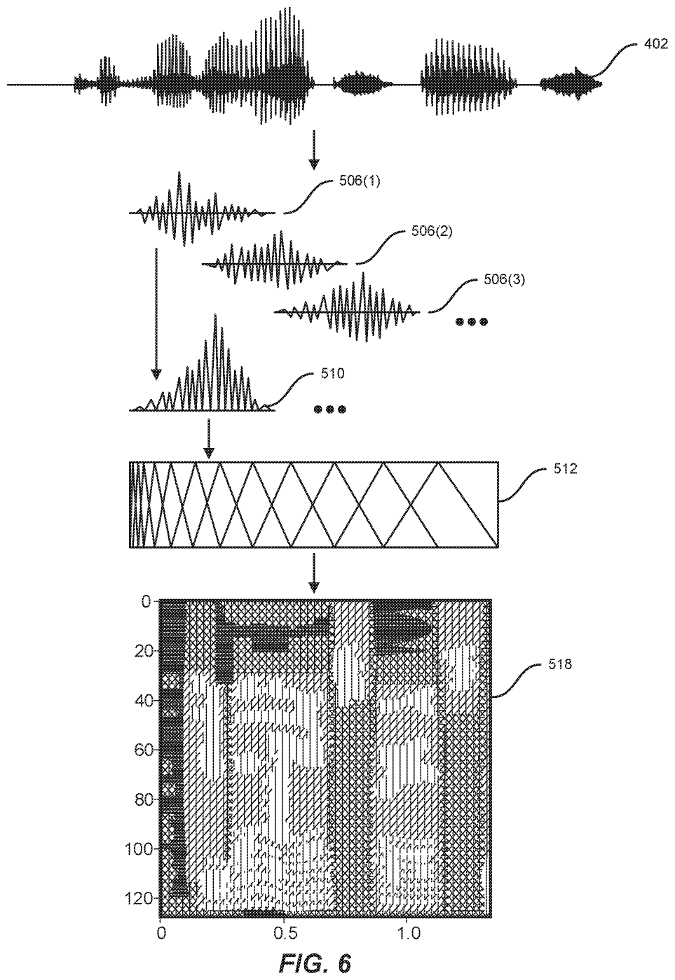

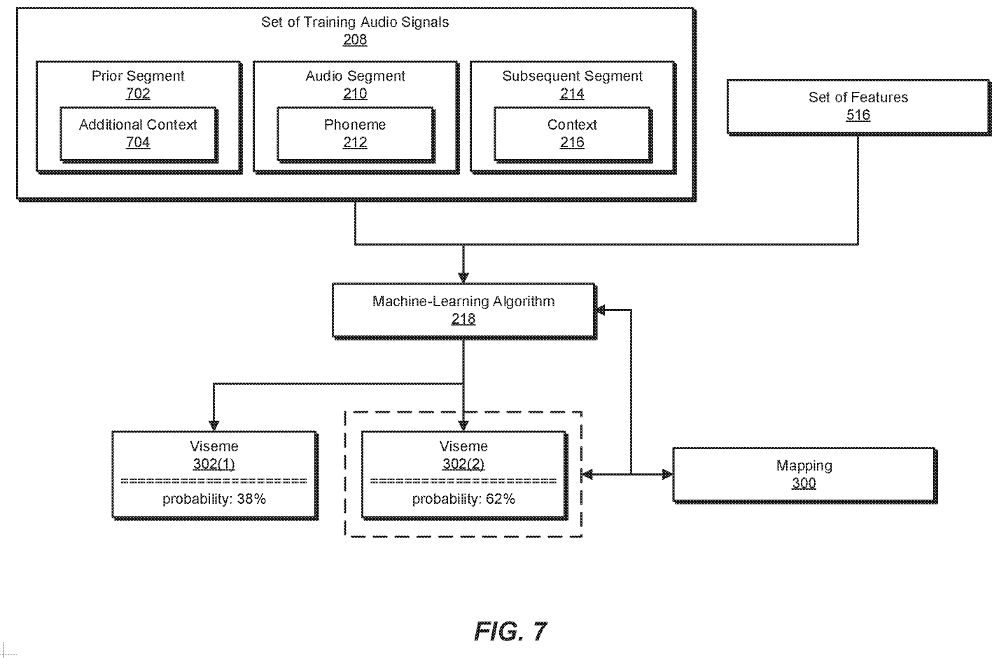

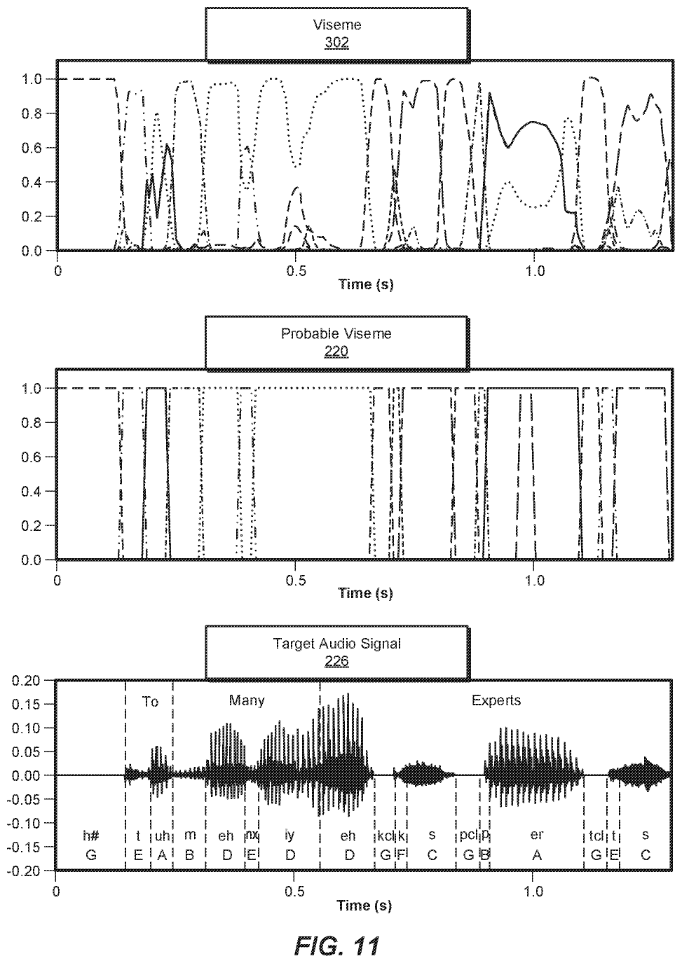

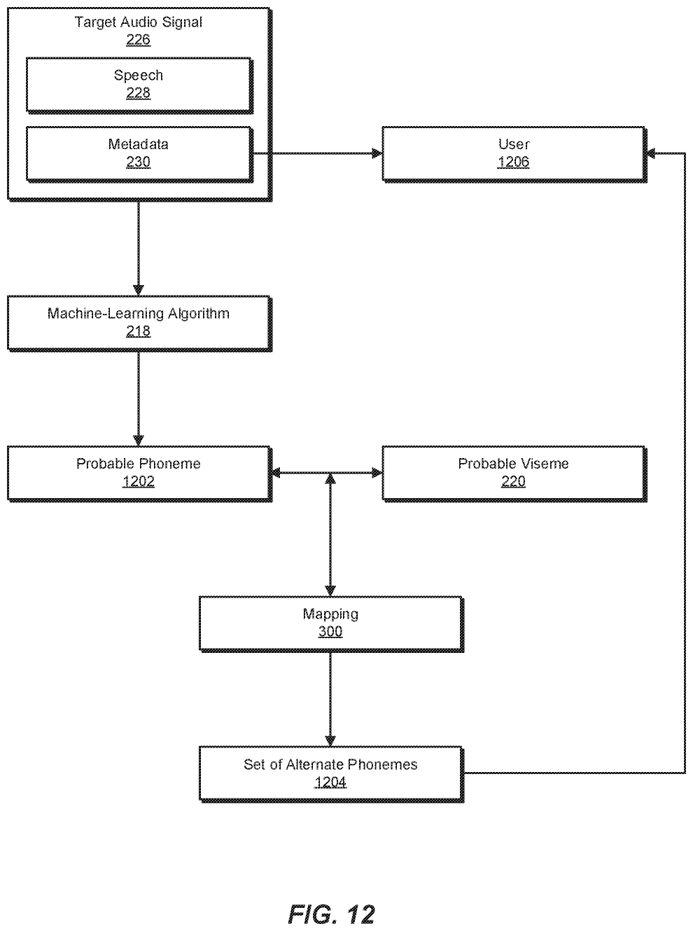

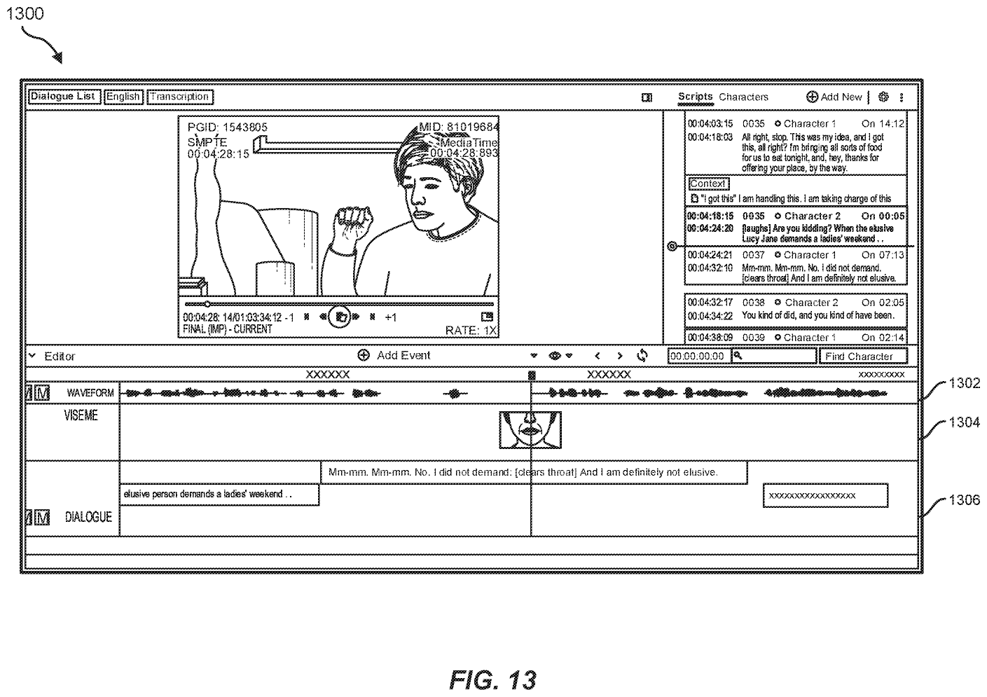

The following will provide, with reference to FIG. 1, detailed descriptions of computer-implemented methods for automatically identifying phonemes and visemes. Detailed descriptions of a corresponding exemplary system will be provided in connection with FIG. 2. Detailed descriptions of an exemplary mapping of visemes and phonemes will be provided in connection with FIG. 3. In addition, detailed descriptions of an exemplary audio signal with exemplary labels for phonemes will be provided in connection with FIG. 4. Next, detailed descriptions of an exemplary feature extraction for an exemplary set of features will be provided in connection with FIGS. 5 and 6. Additionally, detailed descriptions of the exemplary training, validation, and testing of exemplary machine-learning algorithms will be provided in connection with FIGS. 7-10. Detailed descriptions of detecting phonemes and visemes in an exemplary target audio signal will also be provided in connection with FIG. 11. Detailed descriptions of identifying an exemplary set of alternate phonemes will be provided in connection with FIG. 12. Furthermore, detailed descriptions of an interface for presenting viseme recognition results will be provided in connection with FIG. 13.

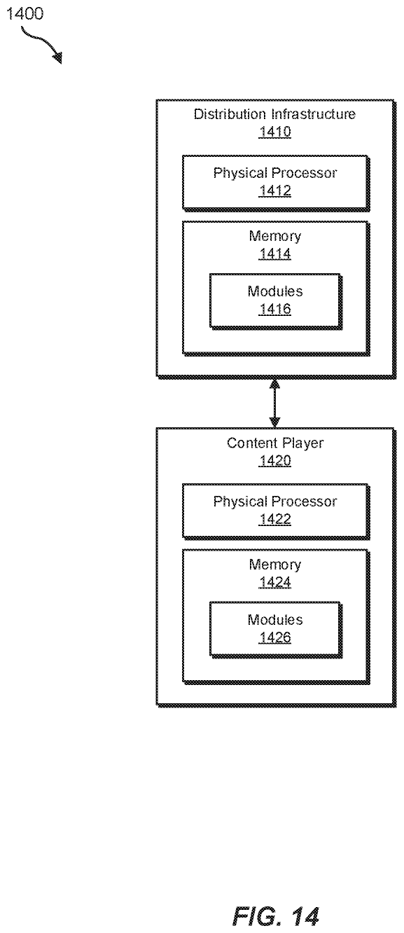

Because many of the embodiments described herein may be used with substantially any type of computing network, including distributed networks designed to provide video content to a worldwide audience, various computer network and video distribution systems will be described with reference to FIGS. 14-16. These figures will introduce the various networks and distribution methods used to provision video content to users.

FIG. 1 is a flow diagram of an exemplary computer-implemented method 100 for automatically identifying phonemes and visemes. The steps shown in FIG. 1 may be performed by any suitable computer-executable code and/or computing system, including the computing device 200 in FIG. 2 and the systems illustrated in FIGS. 14-16. In one example, each of the steps shown in FIG. 1 may represent an algorithm whose structure includes and/or is represented by multiple sub-steps, examples of which will be provided in greater detail below.

As illustrated in FIG. 1, at step 110, one or more of the systems described herein may train a machine-learning algorithm to use look-ahead to improve effectiveness of identifying visemes corresponding to audio signals by, for at least one audio segment in a set of training audio signals, evaluating the audio segment and a subsequent audio segment. As an example, FIG. 2 shows a block diagram of an exemplary computing device 200 for automatically identifying phonemes and visemes. As illustrated in FIG. 2, a training module 202 may, as part of computing device 200, train a machine-learning algorithm 218 by, for an audio segment 210 in a set of training audio signals 208, evaluating audio segment 210 and a subsequent segment 214. In this example, audio segment 210 includes at least a portion of a phoneme 212, and subsequent segment 214 contains contextual audio that comes after audio segment 210 and may provide context 216 about a viseme that maps to phoneme 212.

According to certain embodiments, the term “look-ahead” may generally refer to any procedure or process that looks at one or more segments of audio that come after (e.g., in time) a target audio segment to help identify visemes that correspond to the target audio segment. The systems described herein may look ahead to any suitable number of audio segments of any suitable length to obtain additional context that may help a machine-learning algorithm more effectively identify visemes that correspond to the target audio signal. These future audio segments, which may be referred to as “subsequent segments,” may contain context that inform and improve viseme detection. The context found in the subsequent segments may be additional sounds a speaker makes that follow a particular phoneme in the target audio signal. The context may also be any other audible cue that a machine-learning algorithm may use to more accurately identify which viseme(s) may correspond to the target audio segment.

In some embodiments, computing device 200 may generally represent any type or form of computing device capable of processing audio signal data. Examples of computing device 200 may include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device. Additionally, computing device 200 may include various components of FIGS. 14-16.

In some examples, the term “machine-learning algorithm” generally refers to a computational algorithm that may learn from data in order to make predictions. Examples of machine-learning algorithms may include, without limitation, support vector machines, neural networks, clustering, decision trees, regression analysis, classification, variations or combinations of one or more of the same, and/or any other suitable supervised, semi-supervised, or unsupervised methods. Additionally, the term “neural network” generally refers to a machine-learning method that can learn from unlabeled data using multiple processing layers in a semi-supervised or unsupervised way, particularly for pattern recognition. Examples of neural networks may include deep belief neural networks, multilayer perceptrons (MLPs), temporal convolutional networks (TCNs), and/or any other method for weighting input data to estimate a function.

In one embodiment, the term “phoneme” generally refers to a distinct unit of sound in a language that is distinguishable from other speech. Similarly, in one embodiment, the term “viseme” generally refers to a distinct unit of facial image or expression that describes a phoneme or spoken sound. For example, the practice of lip reading may depend on visemes to determine probable speech. However, in some embodiments, multiple sounds may look similar when spoken, thus mapping each viseme to a set of phonemes.

The systems described herein may perform step 110 in a variety of ways. In some examples, the viseme that maps to phoneme 212 of FIG. 2 may include a viseme 302 in a known mapping 300 as illustrated in the truncated example of FIG. 3. In these examples, mapping 300 may include multiple phonemes, or a set of phonemes 304, that map to each viseme. For example, viseme C showing a partially open mouth and closed jaw may map to phonemes indicating an “s” or a “z” sound in the English language. In alternate examples, each viseme may map to a single phoneme, resulting in a larger total number of visemes, or multiple visemes may be combined to represent larger sets of phonemes, resulting in a smaller total number of visemes. Additionally, mapping 300 may include a smaller set of distinctive visemes determined to be more important for mapping or for purposes such as translation for audio or video dubbing. In some examples, mapping 300 may include a standardized set of visemes used in industry, such as a common set of twelve visemes used in animation. Alternatively, mapping 300 may include a mapping of visemes identified by machine-learning algorithm 218 or other methods that determine an optimal number of visemes required to distinguish different phonemes.

In one embodiment, training machine-learning algorithm 218 may include identifying a start time and an end time for each phoneme, including phoneme 212, in set of training audio signals 208 by detecting prelabeled phonemes and/or aligning estimated phonemes to a script of each training audio signal in set of training audio signals 208. In this embodiment, the script may include a script for a movie or show or may include a phonetic transcription of an audio file. As illustrated in FIG. 4, a training audio signal 402, represented as an audio frequency pattern, may be matched to a script 404, and each phoneme 212 may be generally aligned with the words of script 404 to help identify the start and end times when compared with training audio signal 402. In this example, a language processing software application may match the start and end times of phonemes to training audio signal 402 based on script 404. In alternate examples, a user may manually review training audio signal 402 to identify the start and end times of phonemes.

According to some embodiments, the term “pre-labeled phoneme” generally refers to any phoneme that has already been identified and tagged (e.g., with metadata) in an audio segment. Phoneme's may be prelabeled in any suitable manner. For example, a phoneme may be prelabeled by a user listening to the audio, by a speech detection system, and/or in any other suitable manner.

In some embodiments, training module 202 may train machine-learning algorithm 218 by extracting a set of features from set of training audio signals 208, where each feature in the set of features may include a spectrogram that indicates energy levels for different frequency bands of a training audio signal, such as training audio signal 402. The term “feature,” as used herein, generally refers to a value or vector derived from data that enables it to be measured and/or interpreted as part of a machine-learning algorithm. Examples of features may include numerical data that quantizes a factor, textual data used in pattern recognition, graphical data, or any other format of data that may be analyzed using statistical methods or machine learning. In these embodiments, a feature may include a spectrogram, represented as a set of coefficients or frequency bands over time. As used herein, the term “frequency band” generally refers to a range of frequencies of a signal. Additionally, training module 202 may train machine-learning algorithm 218 on set of training audio signals 208 using the extracted set of features.

In the above embodiments, training module 202 may extract the set of features by, for each training audio signal, dividing the training audio signal into overlapping windows of time, performing a transformation on each windowed audio signal to convert a frequency spectrum for the window of time to a power spectrum indicating a spectral density of the windowed audio signal, computing filter banks for the training audio signal by applying filters that at least partially reflect a scale of human hearing to each power spectrum, and calculating the spectrogram of the training audio signal by combining coefficients of the filter banks.

In some examples, the term “frequency spectrum” generally refers to a range of frequencies for a signal. Similarly, in some examples, the term “power spectrum” generally refers to a distribution of power for the frequency components of a signal. In these examples, the term “spectral density” generally refers to the power spectrum represented as a distribution of frequency components over time. For example, the disclosed systems may perform a Fourier transform on a time-domain signal to a representation of the signal in a frequency spectrum. In some examples, the term “filter bank” generally refers to an array of filters that eliminates signals outside of a particular range, such as by filtering out outlying frequencies of an audio signal.

In the above embodiments, extracting the set of features may further include applying a pre-emphasis filter to set of training audio signals 208 to balance frequencies and reduce noise in set of training audio signals 208. For example, the pre-emphasis filter may reduce extreme frequencies while amplifying average frequencies to better distinguish between subtle differences. Additionally, dividing the training audio signal into windows of time may include applying a window function to taper the windowed audio signal within each overlapping window of time of the training audio signal. In some examples, the term “window function” may generally refer to a mathematical function performed on a signal to truncate the signal within an interval. In these examples, the window function may truncate a signal by time and may appear symmetrical with tapered ends. In these examples, the length of time for each window may differ or may depend on an ideal or preferred method for training machine-learning algorithm 218.

Furthermore, in the above embodiments, calculating the spectrogram may include performing a logarithmic function to convert the frequency spectrum to a mel scale, extracting frequency bands by applying the filter banks to each power spectrum, performing an additional transformation to the filter banks to decorrelate the coefficients of the filter banks, and/or computing a new set of coefficients from the transformed filter banks. In some embodiments, the additional transformation may include the logarithmic function. In other examples, the additional transformation may include a discrete cosine transform and/or other data transformations. In some examples, the term “mel scale” may generally refer to a scale of sounds as judged by human listeners, thereby mimicking the range of human hearing and human ability to distinguish between pitches. For example, the disclosed systems may use a set of 64 mel frequencies to derive a 64-dimensional feature or use a set of 128 mel frequencies to derive a 128-dimensional feature.

In additional embodiments, extracting the set of features may further include standardizing the set of features for set of training audio signals 208 to scale the set of features. In these embodiments, the standardization may include a method to enforce a zero mean and a single unit of variance for the distribution of the set of features. In other words, the disclosed systems may normalize the standardized set of features for each speech sample. Furthermore, although illustrated as a single set of training audio signals in FIG. 2, set of training audio signals 208 may represent two separate sets of audio signals used to extract features and to train machine-learning algorithm 218.

In the example of FIG. 5, set of training audio signals 208 may include a training audio signal 402(1) and a training audio signal 402(2). In this example, training module 202 may apply a pre-emphasis filter 502 to each signal and subsequently use a window function 504 to divide training audio signal 402(1) into windowed audio signals 506(1)-(3) and training audio signal 402(2) into windowed audio signals 506(4)-(5). Subsequently, in this example, a transformation 508 may transform windowed audio signals 506(1)-(5) into power spectrums 510(1)-(5), respectively. In this example, training module 202 may then calculate a filter bank 512 for power spectrums 510(1)-(5) and perform an additional transformation 514 to obtain a set of features 516, with a feature 518(1) corresponding to training audio signal 402(1) and a feature 518(2) corresponding to training audio signal 402(2).

As illustrated in FIG. 6, training audio signal 402 may represent a frequency signal that may be divided into three overlapping windowed audio signals 506(1)-(3) or more windowed audio signals. Each windowed audio signal may then be transformed into a power spectrum, such as transforming windowed audio signal 506(1) into a power spectrum 510. In this example, training module 202 may then combine these power spectrums to create filter bank 512, which may represent a mel scale. For example, training module 202 may perform the logarithmic function on power spectrum 510. Alternatively, training module 202 may compute filter bank 512 based on the mel scale, independent of power spectrum 510, and then apply filter bank 512 to power spectrum 510 and other transformed power spectrums to compute a feature 518, illustrated as a spectrogram. In this example, training module 202 may extract feature 518 by a similar method to computation of mel frequency cepstral coefficients (MFCCs). In additional examples, feature 518 may represent a standardized feature derived from training audio signal 402.

In some embodiments, training module 202 may train machine-learning algorithm 218 of FIG. 2 by, for each audio segment in set of training audio signals 208, calculating, for one or more visemes, the probability of the viseme mapping to phoneme 212 of audio segment 210. In these embodiments, an audio segment may represent a single audio file, a portion of an audio file, a frame of audio, and/or a length of an audio signal useful for training machine-learning algorithm 218. In these embodiments, training module 202 may then select the viseme with a high probability of mapping to phoneme 212 based on context 216 from subsequent segment 214 and modify machine-learning algorithm 218 based on a comparison of the selected viseme to a known mapping of visemes to phonemes. For example, as illustrated in FIG. 3, training module 202 may compare the selected viseme to mapping 300. Furthermore, in some embodiments, training module 202 may select the viseme with the high probability of mapping to phoneme 212 by further adjusting the selection based on additional context from a prior segment that includes additional contextual audio that comes before audio segment 210.

As shown in FIG. 7, set of training audio signals 208 may include audio segment 210 containing at least a portion of phoneme 212, subsequent segment 214 containing context 216 about a corresponding viseme, and a prior segment 702 containing additional context 704 about the corresponding viseme. In this example, training module 202 may train machine-learning algorithm 218 using set of training audio signals 208 and set of features 516 to determine probabilities of a viseme 302(1) and a viseme 302(2) mapping to phoneme 212. Subsequently, training module 202 may determine viseme 302(2) has a higher probability of mapping to phoneme 212 and compare the selection of viseme 302(2) to mapping 300 to determine an accuracy of the selection. In some examples, training module 202 may find a discrepancy between mapping viseme 302(2) to phoneme 212 and known mapping 300 and may then update machine-learning algorithm 218 to improve the accuracy of calculating the probabilities of mapping visemes.

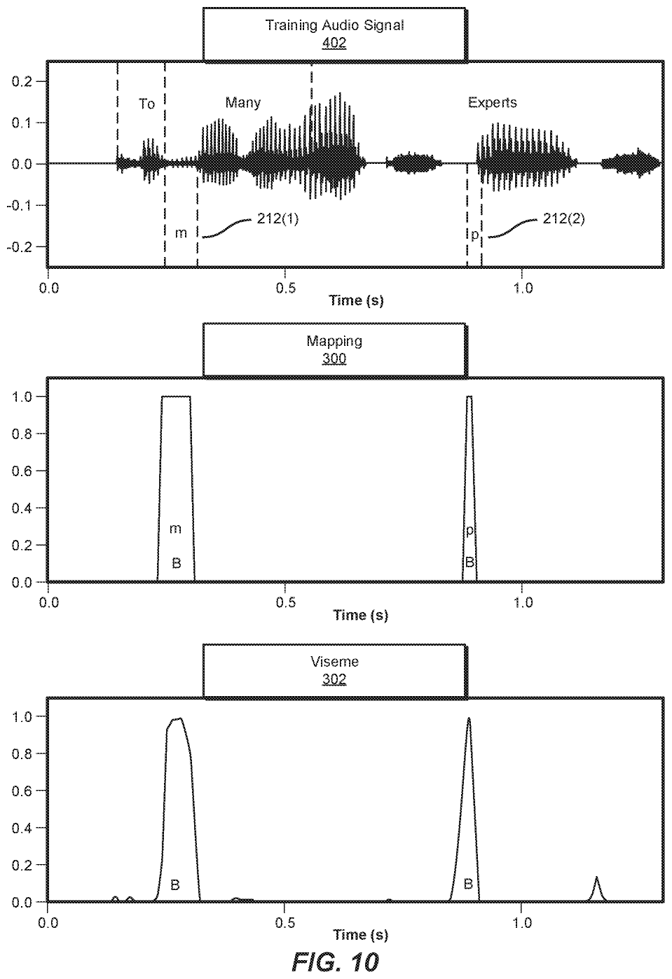

In one embodiment, training module 202 may calculate the probability of mapping a viseme to phoneme 212 by weighting visually distinctive visemes more heavily than other visemes. For example, in some embodiments, a user may want to prioritize certain attributes of visemes that appear more distinctive, such as prioritizing a comparison of visemes with an open mouth and visemes with a closed mouth. In these embodiments, training module 202 may train machine-learning algorithm 218 to identify a smaller set of visemes. For example, as illustrated in FIG. 10, training module 202 may identify a phoneme 212(1) and a phoneme 212(2) in training audio signal 402. In this example, training module 202 may detect a single viseme 302, which may be illustrated as a closed mouth image in FIG. 3, corresponding to phonemes 212(1) and 212(2). In this example, mapping 300 may also be simplified to map a presence or absence of distinctive viseme 302. In contrast, as illustrated in FIG. 11, a set of multiple visemes may be detected and used for mapping.

In some examples, training module 202 may then train machine-learning algorithm 218 by further validating machine-learning algorithm 218 using a set of validation audio signals and testing machine-learning algorithm 218 using a set of test audio signals. In these examples, the validation process may test the ability of machine-learning algorithm 218 to perform as expected, and the testing process may test the usefulness of machine-learning algorithm 218 against other methods of identifying phonemes and visemes. For example, training module 202 may validate machine-learning algorithm 218 by standardizing the set of validation audio signals, applying machine-learning algorithm 218 to the standardized set of validation audio signals, and evaluating an accuracy of mapping visemes to phonemes of the set of validation audio signals by machine-learning algorithm 218. Additionally, training module 202 may test machine-learning algorithm 218 by standardizing the set of test audio signals, applying machine-learning algorithm 218 to the standardized set of test audio signals, comparing an accuracy of mapping visemes to phonemes of the set of test audio signals by machine-learning algorithm 218 with an accuracy of one or more alternate machine-learning algorithms, and selecting an accurate machine-learning algorithm based on the comparison.

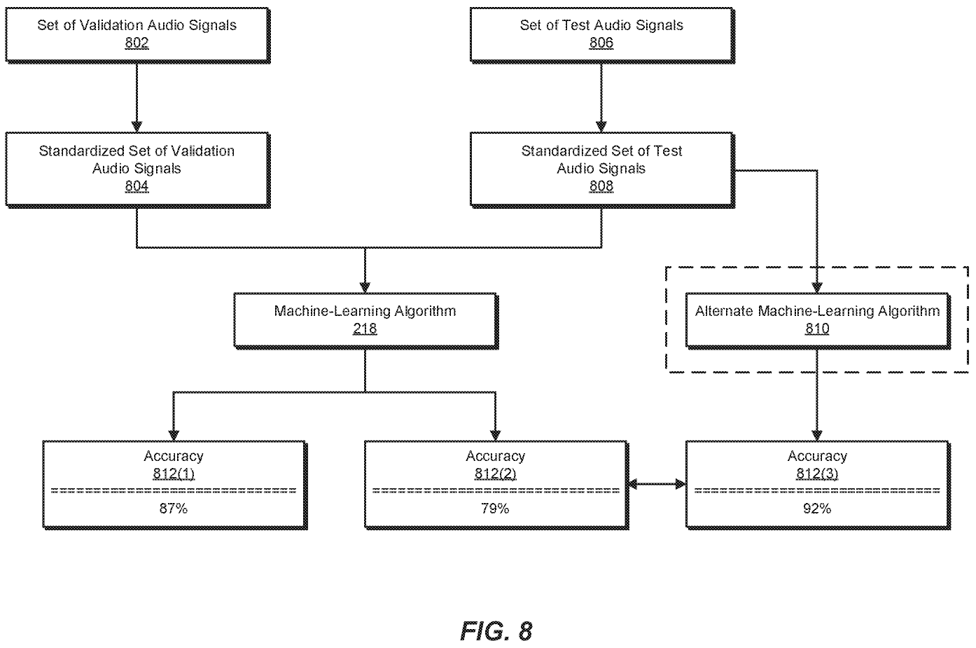

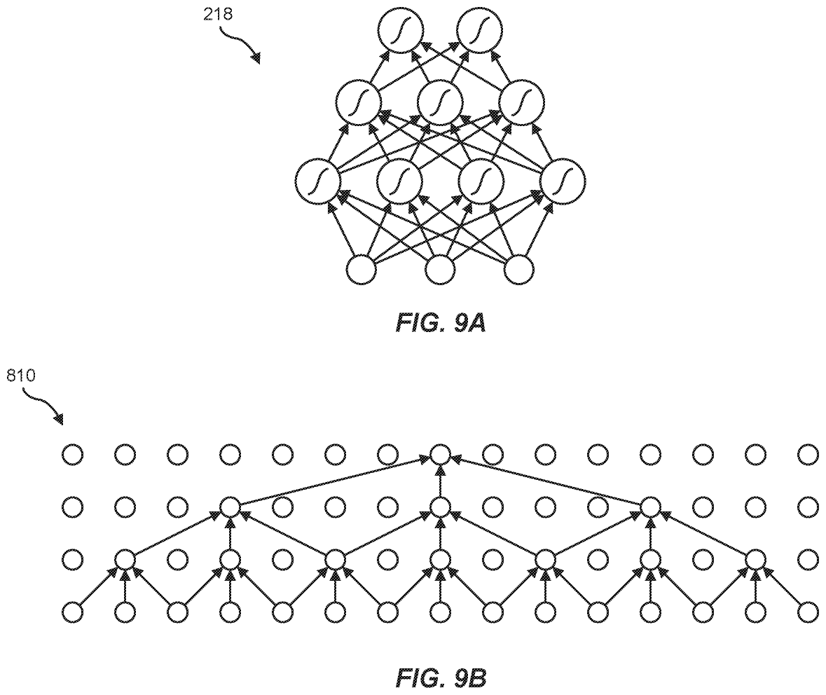

As shown in FIG. 8, training module 202 may standardize a set of validation audio signals 802 into a standardized set of validation audio signals 804 and may standardize a set of test audio signals 806 into a standardized set of test audio signals 808. In this example, training module 202 may calculate an accuracy 812(1) for machine-learning algorithm 218 using standardized set of validation audio signals 804 to verify that the accuracy of identifying phonemes and/or visemes meets a threshold. Additionally, training module 202 may calculate an accuracy 812(2) for machine-learning algorithm 218 and an accuracy 812(3) for an alternate machine-learning algorithm 810 using standardized set of test audio signals 808 for both. For example, as illustrated in FIGS. 9A-9B, machine-learning algorithm 218 may represent an MLP and alternate machine-learning algorithm 810 may represent a TCN. In this example, training module 202 may then determine that alternate machine-learning algorithm 810 is more accurate and may therefore be a better model for speech recognition to identify phonemes and/or visemes.

Returning to FIG. 1, at step 120, one or more of the systems described herein may use the trained machine-learning algorithm to identify at least one probable viseme corresponding to speech in a target audio signal. For example, an identification module 204 may, as part of computing device 200 in FIG. 2, use trained machine-learning algorithm 218 to identify a probable viseme 220 corresponding to speech 228 in a target audio signal 226.

The systems described herein may perform step 120 in a variety of ways. In some examples, machine-learning algorithm 218 may directly identify a most probable viseme based on processing target audio signal 226. In these examples, identification module 204 may then identify a set of phonemes that map to each identified probable viseme in target audio signal 226, such as by selecting set of phonemes 304 from mapping 300 of FIG. 3. In other examples, identification module 204 may use machine-learning algorithm 218 to identify a probable phoneme corresponding to speech 228 of target audio signal 226, rather than probable viseme 220. In these examples, identification module 204 may then select the viseme mapping to the probable phoneme based on known mapping 300 of FIG. 3. Additionally, in some examples, identification module 204 may identify a set of alternate phonemes that map to probable viseme 220 corresponding to the probable phoneme.

For example, as illustrated in FIG. 11, viseme 302 may represent probabilities of different visemes occurring at each point in time of target audio signal 226, as determined by machine-learning algorithm 218. In this example, identification module 204 may then select probable viseme 220 for each point in time. In the example of FIG. 12, identification module 204 may process target audio signal 226, with speech 228, using machine-learning algorithm 218 to obtain a probable phoneme 1202. In this example, mapping 300 may then be used to identify probable viseme 220 and/or to identify a set of alternate phonemes 1204.

Returning to FIG. 1, at step 130, one or more of the systems described herein may record, as metadata of the target audio signal, where the probable viseme occurs within the target audio signal. For example, a recording module 206 may, as part of computing device 200 in FIG. 2, record, as metadata 230 of target audio signal 226, where probable viseme 220 occurs within target audio signal 226.

The systems described herein may perform step 130 in a variety of ways. In some embodiments, recording module 206 may record where probable viseme 220 occurs within target audio signal 226 by identifying and recording a probable start time 222 and a probable end time 224 for each identified probable viseme. In the example of FIG. 11, each probable viseme 220 may include a start and an end time, and recording module 206 may record each start and each end time along with the corresponding probable viseme in metadata 230. For example, recording module 206 may record timestamps for each probable viseme. In one embodiment, recording module 206 may record, as metadata 230, where the set of corresponding phonemes occur within target audio signal 226.

Additionally, in some embodiments, recording module 206 may provide, to a user, metadata 230 indicating where probable viseme 220 occurs within target audio signal 226 and/or provide the set of alternate phonemes that map to probable viseme 220 to improve selection of translations for speech 228. In the example of FIG. 12, recording module 206 may provide metadata 230 to a user 1206, and metadata 230 may include probable viseme 220 and/or set of alternate phonemes 1204. In some examples, user 1206 may use set of phonemes 304 and/or set of alternate phonemes 1204 to determine what translations may match to a video corresponding to target audio signal 226, such as by matching translation dubbing to the timing of lip movements in the video. In alternate examples, user 1206 may determine no equivalent translations may match probable viseme 220, and the video may be reanimated with new visemes to match the translation.

In some embodiments, the term “metadata” generally refers to a set of data that describes and gives information about other data. Metadata may be stored in a digital format along with the media file on any kind of storage device capable of storing media files. Metadata may be implemented as any kind of annotation. For example, the metadata may be implemented as a digital file having Boolean flags, binary values, and/or textual descriptors and corresponding pointers to temporal indices within the media file. Alternatively or additionally, the metadata may be integrated into a video track and/or audio track of the media file. The metadata may thus be configured to cause the playback system to generate visual or audio cues. Example visual cues include displayed textual labels and/or icons, a color or hue of on-screen information (e.g., a subtitle or karaoke style prompt), and/or any other displayed effect that can signal start and end times of probable visemes. Metadata can also be represented as auditory cues, which may include audibly rendered tones or effects, a change in loudness and/or pitch, and/or any other audibly rendered effect that can signal start and/or end times of probable visemes.

Metadata that indicates viseme start and end points may be presented in a variety of ways. In some embodiments, this metadata may be provided to a dubbing and/or translation software program. In the example shown in FIG. 13, a software interface 1300 may present an audio waveform 1302 in a timeline with corresponding visemes 1304 and dialogue 1306. In this example, the viseme of the current speaker may be indicated at the playhead marker. In other embodiments, start and end times of visemes may be presented in any other suitable manner.

As explained above in connection with method 100 in FIG. 1, the disclosed systems and methods may, by training a machine-learning algorithm to recognize phonemes and/or visemes that correspond to certain audio signal patterns, automatically identify phonemes and/or visemes for audio files. Specifically, the disclosed systems and methods may first extract spectrograms from audio signals as features to train the machine-learning algorithm. The disclosed systems and methods may then train the algorithm using not only an audio signal for a specific timeframe of audio but also context from audio occurring before and after the specific timeframe. The disclosed systems and methods may also more accurately map phonemes to visemes, or vice versa, by identifying distinct phonemes and/or visemes occurring in audio signals.

Additionally, the systems and methods described herein may use the identified phonemes and/or visemes to improve automatic speech recognition or machine-assisted translation techniques. For example, the disclosed systems and methods may automatically determine the timestamps for the start and the end of a viseme and identify corresponding phonemes that may be used to select a translated word to match the viseme. The systems and methods described herein may also use the corresponding phonemes to determine whether a video showing the viseme may need to be reanimated to match a better translation dubbing. In other words, the disclosed systems and methods may improve the match between dubbed speech and visemes of a video by matching more natural lip movements to specific sounds. Thus, by training machine-learning methods such as deep-learning neural networks to draw from context before and after a frame of audio, the disclosed systems and methods may more accurately and efficiently identify visemes and/or phonemes for audio files.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

### Example Embodiments

1. A computer-implemented method comprising training a machine-learning algorithm to use look-ahead to improve effectiveness of identifying visemes corresponding to audio signals by, for at least one audio segment in a set of training audio signals, evaluating: the audio segment, where the audio segment includes at least a portion of a phoneme; and a subsequent segment that includes contextual audio that comes after the audio segment and potentially contains context about a viseme that maps to the phoneme; using the trained machine-learning algorithm to identify at least one probable viseme corresponding to speech in a target audio signal; and recording, as metadata of the target audio signal, where the probable viseme occurs within the target audio signal.

2. The method of claim 1, wherein training the machine-learning algorithm comprises identifying a start time and an end time for each phoneme in the set of training audio signals by at least one of: detecting prelabeled phonemes; or aligning estimated phonemes to a script of each training audio signal in the set of training audio signals.

3. The method of claim 1, wherein: training the machine-learning algorithm comprises extracting a set of features from the set of training audio signals, wherein each feature in the set of features comprises a spectrogram indicating energy levels of a training audio signal; and training the machine-learning algorithm on the set of training audio signals is performed using the extracted set of features.

4. The method of claim 3, wherein extracting the set of features comprises, for each training audio signal: dividing the training audio signal into overlapping windows of time; performing a transformation on each windowed audio signal to convert a frequency spectrum for the window of time to a power spectrum indicating a spectral density of the windowed audio signal; computing filter banks for the training audio signal by applying filters that at least partially reflect a scale of human hearing to each power spectrum; and calculating the spectrogram of the training audio signal by combining coefficients of the filter banks.

5. The method of claim 4, wherein extracting the set of features further comprises applying a pre-emphasis filter to the set of training audio signals to balance frequencies and reduce noise in the set of training audio signals.

6. The method of claim 4, wherein dividing the training audio signal comprises applying a window function to taper the windowed audio signal within each overlapping window of time of the training audio signal.

7. The method of claim 4, wherein calculating the spectrogram comprises at least one of: performing a logarithmic function to convert the frequency spectrum to a mel scale; extracting frequency bands by applying the filter banks to each power spectrum; performing an additional transformation to the filter banks to decorrelate the coefficients of the filter banks; or computing a new set of coefficients from the transformed filter banks.

8. The method of claim 4, wherein extracting the set of features further comprises standardizing the set of features for the set of training audio signals to scale the set of features.

9. The method of claim 1, wherein training the machine-learning algorithm comprises, for each audio segment in the set of training audio signals: calculating, for one or more visemes, the probability of the viseme mapping to the phoneme of the audio segment; selecting the viseme with a high probability of mapping to the phoneme based on the context from the subsequent segment; and modifying the machine-learning algorithm based on a comparison of the selected viseme to a known mapping of visemes to phonemes.

10. The method of claim 9, wherein calculating the probability of mapping at least one viseme to the phoneme comprises weighting visually distinctive visemes more heavily than other visemes.

11. The method of claim 9, wherein selecting the viseme with the high probability of mapping to the phoneme further comprises adjusting the selection based on additional context from a prior segment that includes additional contextual audio that comes before the audio segment.

12. The method of claim 1, wherein training the machine-learning algorithm further comprises: validating the machine-learning algorithm using a set of validation audio signals; and testing the machine-learning algorithm using a set of test audio signals.

13. The method of claim 12, wherein validating the machine-learning algorithm comprises: standardizing the set of validation audio signals; applying the machine-learning algorithm to the standardized set of validation audio signals; and evaluating an accuracy of mapping visemes to phonemes of the set of validation audio signals by the machine-learning algorithm.

14. The method of claim 12, wherein testing the machine-learning algorithm comprises: standardizing the set of test audio signals; applying the machine-learning algorithm to the standardized set of test audio signals; comparing an accuracy of mapping visemes to phonemes of the set of test audio signals by the machine-learning algorithm with an accuracy of at least one alternate machine-learning algorithm; and selecting an accurate machine-learning algorithm based on the comparison.

15. The method of claim 1, wherein recording where the probable viseme occurs within the target audio signal comprises identifying and recording a probable start time and a probable end time for each identified probable viseme in the target audio signal.

16. The method of claim 1, further comprising: identifying a set of phonemes that map to each identified probable viseme in the target audio signal; and recording, as metadata of the target audio signal, where the set of phonemes occur within the target audio signal.

17. A system comprising: at least one physical processor; physical memory comprising computer-executable instructions that, when executed by the physical processor, cause the physical processor to: train a machine-learning algorithm to use look-ahead to improve effectiveness of identifying visemes corresponding to audio signals by, for at least one audio segment in a set of training audio signals, evaluating: the audio segment, where the audio segment includes at least a portion of a phoneme; and a subsequent segment that includes contextual audio that comes after the audio segment and potentially contains context about a viseme that maps to the phoneme; uses the trained machine-learning algorithm to identify at least one probable viseme corresponding to speech in a target audio signal; record, as metadata of the target audio signal, where the probable viseme occurs within the target audio signal.

18. The system of claim 17, wherein the machine-learning algorithm is trained to identify at least one of: a probable phoneme corresponding to the speech in the target audio signal; and a set of alternate phonemes that map to the probable viseme corresponding to the probable phoneme in the target audio signal.

19. The system of claim 18, wherein the computer-executable instructions, when executed by the physical processor, further cause the physical processor to: provide the metadata indicating where the probable viseme occurs within the target audio signal to a user; and provide, to the user, the set of alternate phonemes that map to the probable viseme to improve selection of translations for the speech in the target audio signal.

20. A non-transitory computer-readable medium comprising one or more computer-executable instructions that, when executed by at least one processor of a computing device, cause the computing device to: train a machine-learning algorithm to use look-ahead to improve effectiveness of identifying visemes corresponding to audio signals by, for at least one audio segment in a set of training audio signals, evaluating: the audio segment, where the audio segment includes at least a portion of a phoneme; and a subsequent segment that includes contextual audio that comes after the audio segment and potentially contains context about a viseme that maps to the phoneme; use the trained machine-learning algorithm to identify at least one probable viseme corresponding to speech in a target audio signal; and record, as metadata of the target audio signal, where the probable viseme occurs within the target audio signal.

Content that is created or modified using the methods described herein may be used and/or distributed in a variety of ways and/or by a variety of systems. Such systems may include content distribution ecosystems, as shown in FIGS. 14-16.

FIG. 14 is a block diagram of a content distribution ecosystem 1400 that includes a distribution infrastructure 1410 in communication with a content player 1420. In some embodiments, distribution infrastructure 1410 is configured to encode data and to transfer the encoded data to content player 1420 via data packets. Content player 1420 is configured to receive the encoded data via distribution infrastructure 1410 and to decode the data for playback to a user. The data provided by distribution infrastructure 1410 may include audio, video, text, images, animations, interactive content, haptic data, virtual or augmented reality data, location data, gaming data, or any other type of data that may be provided via streaming.

Distribution infrastructure 1410 generally represents any services, hardware, software, or other infrastructure components configured to deliver content to end users. In some examples, distribution infrastructure 1410 includes content aggregation systems, media transcoding and packaging services, network components (e.g., network adapters), and/or a variety of other types of hardware and software. Distribution infrastructure 1410 may be implemented as a highly complex distribution system, a single media server or device, or anything in between. In some examples, regardless of size or complexity, distribution infrastructure 1410 includes at least one physical processor 1412 and at least one memory device 1414. One or more modules 1416 may be stored or loaded into memory 1414 to enable adaptive streaming, as discussed herein.

Content player 1420 generally represents any type or form of device or system capable of playing audio and/or video content that has been provided over distribution infrastructure 1410. Examples of content player 1420 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1410, content player 1420 includes a physical processor 1422, memory 1424, and one or more modules 1426. Some or all of the adaptive streaming processes described herein may be performed or enabled by modules 1426, and in some examples, modules 1416 of distribution infrastructure 1410 may coordinate with modules 1426 of content player 1420 to provide adaptive streaming of multimedia content.

In certain embodiments, one or more of modules 1416 and/or 1426 in FIG. 14 may represent one or more software applications or programs that, when executed by a computing device, may cause the computing device to perform one or more tasks. For example, and as will be described in greater detail below, one or more of modules 1416 and 1426 may represent modules stored and configured to run on one or more general-purpose computing devices. One or more of modules 1416 and 1426 in FIG. 14 may also represent all or portions of one or more special-purpose computers configured to perform one or more tasks.

Physical processors 1412 and 1422 generally represent any type or form of hardware-implemented processing unit capable of interpreting and/or executing computer-readable instructions. In one example, physical processors 1412 and 1422 may access and/or modify one or more of modules 1416 and 1426, respectively. Additionally or alternatively, physical processors 1412 and 1422 may execute one or more of modules 1416 and 1426 to facilitate adaptive streaming of multimedia content. Examples of physical processors 1412 and 1422 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1414 and 1424 generally represent any type or form of volatile or non-volatile storage device or medium capable of storing data and/or computer-readable instructions. In one example, memory 1414 and/or 1424 may store, load, and/or maintain one or more of modules 1416 and 1426. Examples of memory 1414 and/or 1424 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

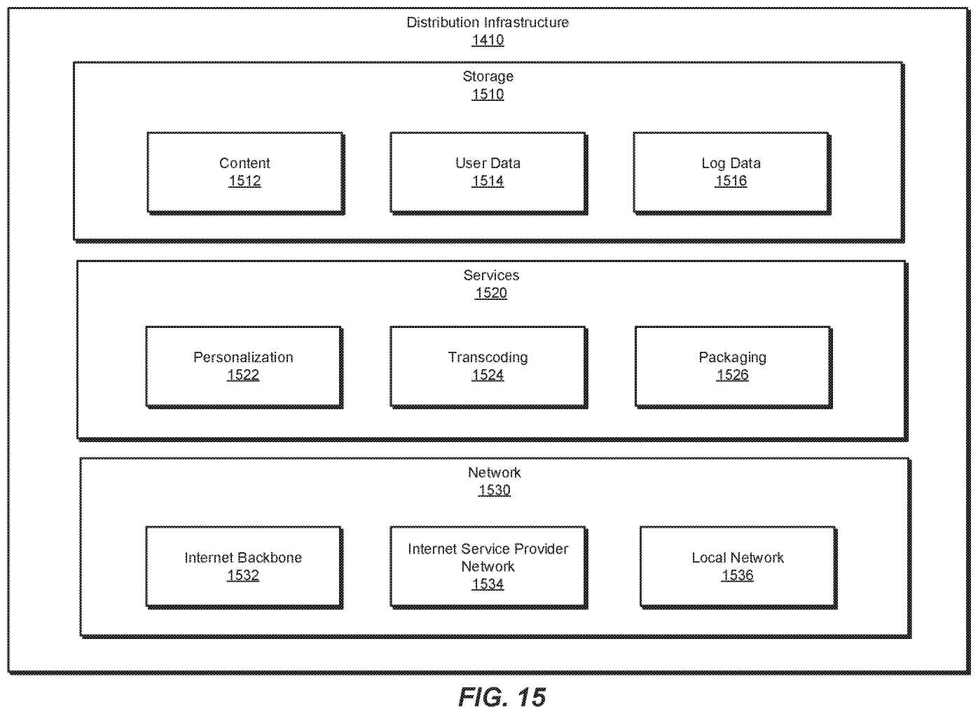

FIG. 15 is a block diagram of exemplary components of content distribution infrastructure 1410 according to certain embodiments. Distribution infrastructure 1410 may include storage 1510, services 1520, and a network 1530. Storage 1510 generally represents any device, set of devices, and/or systems capable of storing content for delivery to end users. Storage 1510 may include a central repository with devices capable of storing terabytes or petabytes of data and/or may include distributed storage systems (e.g., appliances that mirror or cache content at Internet interconnect locations to provide faster access to the mirrored content within certain regions). Storage 1510 may also be configured in any other suitable manner.

As shown, storage 1510 may store, among other items, content 1512, user data 1514, and/or log data 1516. Content 1512 may include television shows, movies, video games, user-generated content, and/or any other suitable type or form of content. User data 1514 may include personally identifiable information (PII), payment information, preference settings, language and accessibility settings, and/or any other information associated with a particular user or content player. Log data 1516 may include viewing history information, network throughput information, and/or any other metrics associated with a user's connection to or interactions with distribution infrastructure 1410.

Services 1520 may include personalization services 1522, transcoding services 1524, and/or packaging services 1526. Personalization services 1522 may personalize recommendations, content streams, and/or other aspects of a user's experience with distribution infrastructure 1410. Encoding services 1524 may compress media at different bitrates which may enable real-time switching between different encodings. Packaging services 1526 may package encoded video before deploying it to a delivery network, such as network 1530, for streaming.

Network 1530 generally represents any medium or architecture capable of facilitating communication or data transfer. Network 1530 may facilitate communication or data transfer via transport protocols using wireless and/or wired connections. Examples of network 1530 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 15, network 1530 may include an Internet backbone 1532, an internet service provider 1534, and/or a local network 1536.

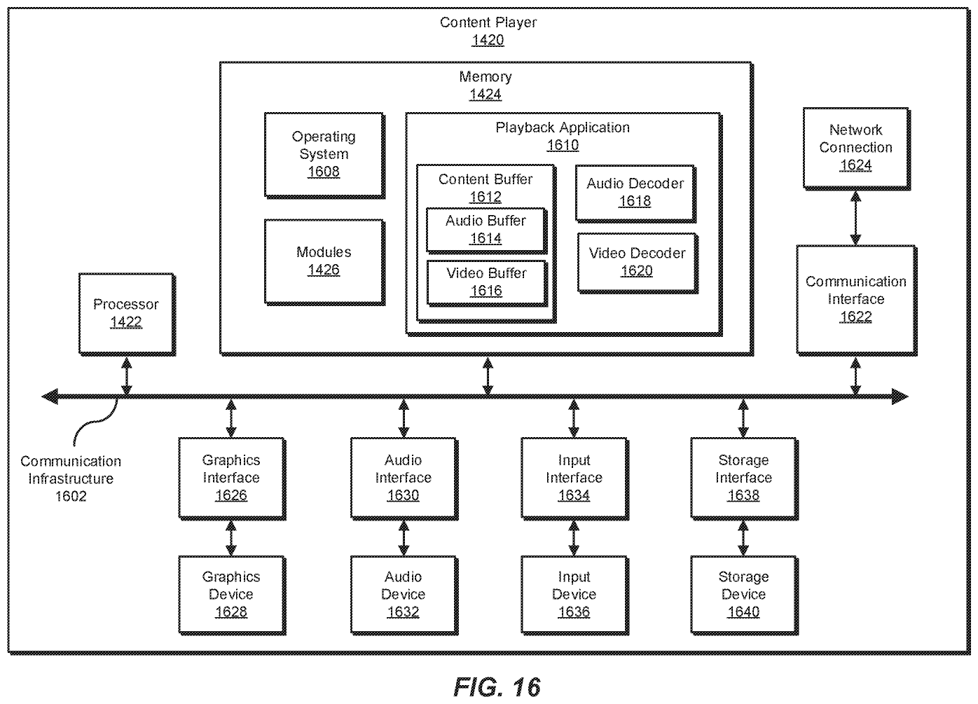

FIG. 16 is a block diagram of an exemplary implementation of content player 1420 of FIG. 3. Content player 1420 generally represents any type or form of computing device capable of reading computer-executable instructions. Content player 1420 may include, without limitation, laptops, tablets, desktops, servers, cellular phones, multimedia players, embedded systems, wearable devices (e.g., smart watches, smart glasses, etc.), smart vehicles, gaming consoles, internet-of-things (loT) devices such as smart appliances, variations or combinations of one or more of the same, and/or any other suitable computing device.

As shown in FIG. 16, in addition to processor 1422 and memory 1424, content player 1420 may include a communication infrastructure 1602 and a communication interface 1622 coupled to a network connection 1624. Content player 1420 may also include a graphics interface 1626 coupled to a graphics device 1628, an input interface 1634 coupled to an input device 1636, and a storage interface 1638 coupled to a storage device 1640.

Communication infrastructure 1602 generally represents any type or form of infrastructure capable of facilitating communication between one or more components of a computing device. Examples of communication infrastructure 1602 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1424 generally represents any type or form of volatile or non-volatile storage device or medium capable of storing data and/or other computer-readable instructions. In some examples, memory 1424 may store and/or load an operating system 1608 for execution by processor 1422. In one example, operating system 1608 may include and/or represent software that manages computer hardware and software resources and/or provides common services to computer programs and/or applications on content player 1420.

Operating system 1608 may perform various system management functions, such as managing hardware components (e.g., graphics interface 1626, audio interface 1630, input interface 1634, and/or storage interface 1638). Operating system 1608 may also process memory management models for playback application 1610. The modules of playback application 1610 may include, for example, a content buffer 1612, an audio decoder 1618, and a video decoder 1620. Content buffer 1612 may include an audio buffer 1614 and a video buffer 1616.

Playback application 1610 may be configured to retrieve digital content via communication interface 1622 and play the digital content through graphics interface 1626. A video decoder 1620 may read units of video data from video buffer 1616 and may output the units of video data in a sequence of video frames corresponding in duration to the fixed span of playback time. Reading a unit of video data from video buffer 1616 may effectively de-queue the unit of video data from video buffer 1616. The sequence of video frames may then be rendered by graphics interface 1626 and transmitted to graphics device 1628 to be displayed to a user. Similarly, audio interface 1630 may play audio through audio device 1632.

In situations where the bandwidth of distribution infrastructure 1410 is limited and/or variable, playback application 1610 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 1420 may also include a storage device 1640 coupled to communication infrastructure 1602 via a storage interface 1638. Storage device 1640 generally represent any type or form of storage device or medium capable of storing data and/or other computer-readable instructions. For example, storage device 1640 may be a magnetic disk drive, a solid-state drive, an optical disk drive, a flash drive, or the like. Storage interface 1638 generally represents any type or form of interface or device for transferring data between storage device 1640 and other components of content player 1420.

Many other devices or subsystems may be included in or connected to content player 1420. Conversely, one or more of the components and devices illustrated in FIG. 16 need not be present to practice the embodiments described and/or illustrated herein. The devices and subsystems referenced above may also be interconnected in different ways from that shown in FIG. 16. Content player 1420 may also employ any number of software, firmware, and/or hardware configurations.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive an audio signal to be transformed, transform the audio signal, output a result of the transformation to train a machine-learning algorithm, use the result of the transformation to identify a probable corresponding viseme, and store the result of the transformation to metadata for the audio signal. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
training a machine-learning algorithm to use look-ahead to improve effectiveness of identifying visemes corresponding to audio signals by, for at least one audio segment in a set of training audio signals, evaluating:
the audio segment, where the audio segment includes at least a portion of a phoneme; and
a subsequent segment that includes contextual audio that comes after the audio segment and potentially contains context about a viseme that maps to the phoneme;
using the trained machine-learning algorithm to identify at least one probable viseme corresponding to speech in a target audio signal; and
recording, as metadata of the target audio signal, where the probable viseme occurs within the target audio signal.

2. The method of claim 1, wherein training the machine-learning algorithm comprises identifying a start time and an end time for each phoneme in the set of training audio signals by at least one of:
detecting prelabeled phonemes; or
aligning estimated phonemes to a script of each training audio signal in the set of training audio signals.

3. The method of claim 1, wherein:
training the machine-learning algorithm comprises extracting a set of features from the set of training audio signals, wherein each feature in the set of features comprises a spectrogram indicating energy levels of a training audio signal; and
training the machine-learning algorithm on the set of training audio signals is performed using the extracted set of features.

4. The method of claim 3, wherein extracting the set of features comprises, for each training audio signal:
dividing the training audio signal into overlapping windows of time;
performing a transformation on each windowed audio signal to convert a frequency spectrum for the window of time to a power spectrum indicating a spectral density of the windowed audio signal;
computing filter banks for the training audio signal by applying filters that at least partially reflect a scale of human hearing to each power spectrum; and
calculating the spectrogram of the training audio signal by combining coefficients of the filter banks.

5. The method of claim 4, wherein extracting the set of features further comprises applying a pre-emphasis filter to the set of training audio signals to balance frequencies and reduce noise in the set of training audio signals.

6. The method of claim 4, wherein dividing the training audio signal comprises applying a window function to taper the windowed audio signal within each overlapping window of time of the training audio signal.

7. The method of claim 4, wherein calculating the spectrogram comprises at least one of:
performing a logarithmic function to convert the frequency spectrum to a mel scale;
extracting frequency bands by applying the filter banks to each power spectrum;
performing an additional transformation to the filter banks to decorrelate the coefficients of the filter banks; or
computing a new set of coefficients from the transformed filter banks.

8. The method of claim 4, wherein extracting the set of features further comprises standardizing the set of features for the set of training audio signals to scale the set of features.

9. The method of claim 1, wherein training the machine-learning algorithm comprises, for each audio segment in the set of training audio signals:
calculating, for one or more visemes, the probability of the viseme mapping to the phoneme of the audio segment;
selecting the viseme with a high probability of mapping to the phoneme based on the context from the subsequent segment; and
modifying the machine-learning algorithm based on a comparison of the selected viseme to a known mapping of visemes to phonemes.

10. The method of claim 9, wherein calculating the probability of mapping at least one viseme to the phoneme comprises weighting visually distinctive visemes more heavily than other visemes.

11. The method of claim 9, wherein selecting the viseme with the high probability of mapping to the phoneme further comprises adjusting the selection based on additional context from a prior segment that includes additional contextual audio that comes before the audio segment.

12. The method of claim 1, wherein training the machine-learning algorithm further comprises:
validating the machine-learning algorithm using a set of validation audio signals; and
testing the machine-learning algorithm using a set of test audio signals.

13. The method of claim 12, wherein validating the machine-learning algorithm comprises:
standardizing the set of validation audio signals;
applying the machine-learning algorithm to the standardized set of validation audio signals; and
evaluating an accuracy of mapping visemes to phonemes of the set of validation audio signals by the machine-learning algorithm.

14. The method of claim 12, wherein testing the machine-learning algorithm comprises:
standardizing the set of test audio signals;
applying the machine-learning algorithm to the standardized set of test audio signals;
comparing an accuracy of mapping visemes to phonemes of the set of test audio signals by the machine-learning algorithm with an accuracy of at least one alternate machine-learning algorithm; and
selecting an accurate machine-learning algorithm based on the comparison.

15. The method of claim 1, wherein recording where the probable viseme occurs within the target audio signal comprises identifying and recording a probable start time and a probable end time for each identified probable viseme in the target audio signal.

16. The method of claim 1, further comprising:
identifying a set of phonemes that map to each identified probable viseme in the target audio signal; and
recording, as metadata of the target audio signal, where the set of phonemes occur within the target audio signal.

17. A system comprising:
at least one physical processor;
physical memory comprising computer-executable instructions that, when executed by the physical processor, cause the physical processor to:
train a machine-learning algorithm to use look-ahead to improve effectiveness of identifying visemes corresponding to audio signals by, for at least one audio segment in a set of training audio signals, evaluating:
the audio segment, where the audio segment includes at least a portion of a phoneme; and
a subsequent segment that includes contextual audio that comes after the audio segment and potentially contains context about a viseme that maps to the phoneme;
uses the trained machine-learning algorithm to identify at least one probable viseme corresponding to speech in a target audio signal;
record, as metadata of the target audio signal, where the probable viseme occurs within the target audio signal.

18. The system of claim 17, wherein the machine-learning algorithm is trained to identify at least one of:
a probable phoneme corresponding to the speech in the target audio signal; and
a set of alternate phonemes that map to the probable viseme corresponding to the probable phoneme in the target audio signal.

19. The system of claim 18, wherein the computer-executable instructions, when executed by the physical processor, further cause the physical processor to:
provide the metadata indicating where the probable viseme occurs within the target audio signal to a user; and
provide, to the user, the set of alternate phonemes that map to the probable viseme to improve selection of translations for the speech in the target audio signal.

20. A non-transitory computer-readable medium comprising one or more computer-executable instructions that, when executed by at least one processor of a computing device, cause the computing device to:
train a machine-learning algorithm to use look-ahead to improve effectiveness of identifying visemes corresponding to audio signals by, for at least one audio segment in a set of training audio signals, evaluating:
the audio segment, where the audio segment includes at least a portion of a phoneme; and
a subsequent segment that includes contextual audio that comes after the audio segment and potentially contains context about a viseme that maps to the phoneme;
use the trained machine-learning algorithm to identify at least one probable viseme corresponding to speech in a target audio signal; and
record, as metadata of the target audio signal, where the probable viseme occurs within the target audio signal.
